(19) United States
(12) Patent Application Publication
(10) Pub. No.: US 2014/0127956 A1
(43) Pub. Date: May 8, 2014

(54) A Retractable Wheel Assembly for an Amphibian

(71) Applicants: Alan Timothy Gibbs, London (GB); Nigel Stuart Ikin, Warwickshire (GB)

(72) Inventors: Alan Timothy Gibbs, London (GB); Nigel Stuart Ikin, Warwickshire (GB)

(73) Assignee: Gibbs Technologies Limited, Warwickshire (GB)

(21) Appl. No.: 14/126,014

(22) PCT Filed: Jun. 13, 2012
(86) PCT No.: PCT/GB2012/051358

§ 371 Date: Dec. 13, 2013

(30) Foreign Application Priority Data
Jun. 13, 2011 (GB) 1109887.8

(51) Int. Cl. B60F 3/00

(52) U.S. Cl. CPC B60F 3/0007
USPC 440/12.52

(57) ABSTRACT

A retractable land propulsion assembly for an amphibian including a retraction linkage movable between a protracted position and a retracted position, an actuator for moving the retraction linkage between the protracted position and retracted position, and at least one wheel and/or track drive. When the retraction linkage is protracted then the retraction linkage supports and/or holds the at least one wheel and/or track drive in a ground engaging position for use on land. The retraction linkage comprises at least one component or part or portion thereof that passes through an overcentre position on protraction to prevent forces received in use via the at least one wheel and/or track drive from acting to retract the retraction linkage.

### BACKGROUND OF THE INVENTION

The present invention relates to a retractable wheel assembly particularly suitable for use in an amphibian capable of travel on land and water. More particularly, the retractable wheel assembly is suitable for use in a high speed amphibian which is capable of planing on water. The present invention also relates to an amphibian having such a retractable wheel assembly.

Retractable wheel assemblies for use in amphibians are known in the art. These retractable wheel assemblies are typically used to lift the wheels clear of the water to reduce drag when operating the amphibian on water. Many of these known wheel retraction systems are complicated and/or provide poor suspension when the vehicle is used on land. For example, U.S. Pat. No. 5,755,173 describes the use for each wheel of a transversely-extending single arm which swings upwardly around a longitudinal axis of the vehicle. This results in compromised suspension on land, as there is too much camber change on bump and on rebound. WO02/16152 describes a trailing arm suspension. This gives zero camber change to the wheel when one side of the car loads up during cornering. This provides for poor road holding when on land. U.S. Pat. No. 3,755,838 also describes a trailing arm suspension. This again provides poor road holding on land.

More recently, however, the applicant has developed retractable wheel assemblies for use in a new class of high speed amphibians having at least one retractable wheel and which are capable of planing on water. The retractable wheel assemblies include retractable suspension assemblies and provide for improved suspension and thus road handling when the amphibian is operated on land.

The remains, however, a need to improve on these prior art retractable wheel assemblies by providing increased flexibility in terms of the off-road capability for use of a high speed amphibian on land. The need to retract and protract wheel assemblies reliably in a manner that can deal with extremes of normal and shock loading with off-road use, particularly in a large and/or heavily loaded amphibian, presents significant problems in terms of suspension performance, ground clearance, packaging, weight distribution and also in terms of how the resulting power transmission pathways and steering can be effected.

### SUMMARY OF THE INVENTION

The present invention provides a retractable wheel assembly whose geometry is such that an overcentre action upon wheel protraction can be achieved so that that forces received via the wheel in the protracted position are transmitted along an overcentre pathway which actually serves to urge and keep the retractable wheel assembly protracted with full suspension capability (if present), yet does so without compromising the wheel retraction function, steering or drive function where provided. A bar or other such member may be provided to act as a mechanical end stop to limit the travel of the overcentre action. In a preferred embodiment, the retractable wheel assembly can additionally be locked in the overcentre position, mechanically, electrically and/or hydraulically. The overcenter position of the retraction link does not require, on a relative basis, a large force to be maintained if such a force is applied in a direction approximately perpendicular to the axis of the link near the pivot. Therefore, a spring-loaded gate feature, detent, pin, magnetic or electro-magnetic lock or other similar device can be employed in place of, or in addition to, a hydraulic or other positive locking mechanisms.

Accordingly, in a first aspect, the present invention provides a retractable wheel and/or track drive assembly for an amphibian comprising:
a retraction linkage movable between a protracted position and a retracted position;
an actuator for moving the retraction linkage between the protracted position and retracted position; and
at least one wheel and/or track drive, wherein:
when the retraction linkage is protracted then the retraction linkage supports and/or holds the at least one wheel and/or track drive in a ground engaging position for use on land;
the retraction linkage comprises at least one component or part or portion thereof that passes through an overcentre position on protraction to prevent forces received in use via the at least one wheel and/or track drive from acting to retract the retraction linkage.

Preferably, when the retraction linkage is retracted then the retraction linkage supports and/or holds the at least one wheel and/or track drive in a non ground engaging position for use on water.

Preferably, the retractable wheel and/or track drive assembly further comprises suspension means. Preferably, the suspension means is also retractable and protractable upon actuation of the actuator. Preferably, the suspension means is a spring damper strut, a torsion bar and damper, a hydropneumatic unit and/or a gas or air spring and/or any hybrid thereof.

Preferably, the actuator is a hydraulic, electric and/or pneumatic actuator and/or any hybrid thereof.

Preferably, the retraction linkage comprises an upper control arm, a lower control arm and a suspension upright.

Preferably, the retraction linkage further comprises a retract arm.

Preferably, the upper control arm and lower control arm are wishbones.

Preferably, the retractable wheel and/or track drive assembly further comprising locking, holding and/or urging means to lock, hold and/or urge the retraction linkage in the overcentre position after protraction.

Preferably, the at least one wheel and/or track drive is retractable and protractable about an axis or axes each generally or substantially perpendicular to the axis of rotation of the wheel and/or track drive of the retractable wheel or track drive assembly.

In a further aspect, the present invention provides an amphibian comprising one or more of the retractable wheel and/or track drive assemblies as set forth herein.

Preferably, one or more of the at least one wheel and/or track drive may be retracted above the water line for use on water, and at least a portion of the one or more at least one wheel and/or track drive is protracted below the lowermost part of the hull for use on land.

Preferably, one or more of the at least one wheel and/or track drive may be retracted above the lowermost part of the hull for use on water, and at least a portion of the one or more at least one wheel and/or track drive is protracted below the lowermost part of the hull for use on land.

Preferably, the at least one wheel and/or track drive is retractable and protractable about an axis or axes each generally or substantially parallel to a longitudinal axis of the amphibian.

Preferably, the amphibian further comprises a prime mover and a marine propulsion means and when operated in the marine mode the marine propulsion means can power the amphibian to a speed where sufficient hydrodynamic lift is achieved for the vehicle to plane.

Preferably, when the amphibian is operated in the land mode it can be driven in any available driven wheel configuration, including one, two, three, four, five and six wheel drive or track drive.

In a further aspect, the present invention provides a retractable wheel and/or track drive assembly for an amphibian substantially as set forth and described herein with reference to or as shown in the accompanying drawings.

In a further aspect, the present invention provides an amphibian comprising one or more of the retractable wheel and/or track drive assemblies substantially as set forth and described herein with reference to or as shown in the accompanying drawings.

### BRIEF DESCRIPTION OF THE DRAWINGS

Preferred embodiments of the present invention will now be described by way of example only with reference to the accompanying drawings, in which:

FIG. 1 is a schematic front elevation view of a retractable wheel assembly according to the present invention in a protracted position (wheel not shown for clarity);

FIG. 2 is a schematic plan view from above of the retractable wheel assembly of FIG. 1 in a protracted position (wheel not shown for clarity);

FIG. 3 is a schematic side elevation view of the retractable wheel assembly of FIG. 1 in a protracted position (wheel not shown for clarity);

FIG. 4 is a schematic front elevation view of the retractable wheel assembly of FIG. 1 in a retracted position (wheel not shown for clarity);

FIG. 5 is a schematic plan view from above of the retractable wheel assembly of FIG. 1 in a retracted position (wheel not shown for clarity); and

FIG. 6 is a schematic side elevation view of the retractable wheel assembly of FIG. 1 in a retracted position (wheel not shown for clarity.)

### DETAILED DESCRIPTION OF THE PREFERRED EMBODIMENTS

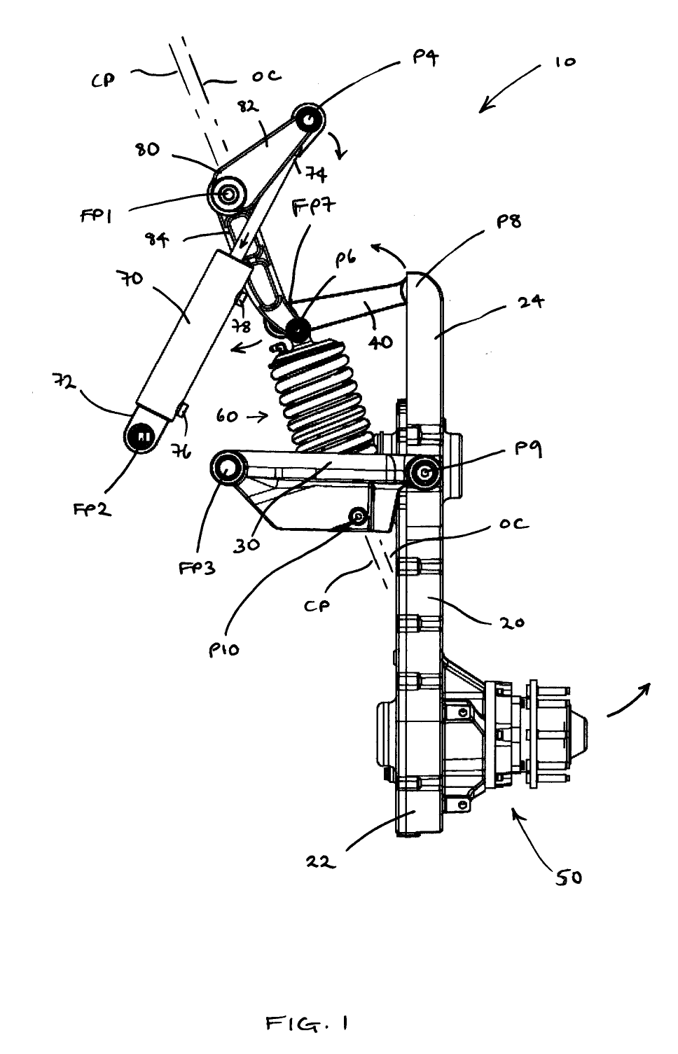

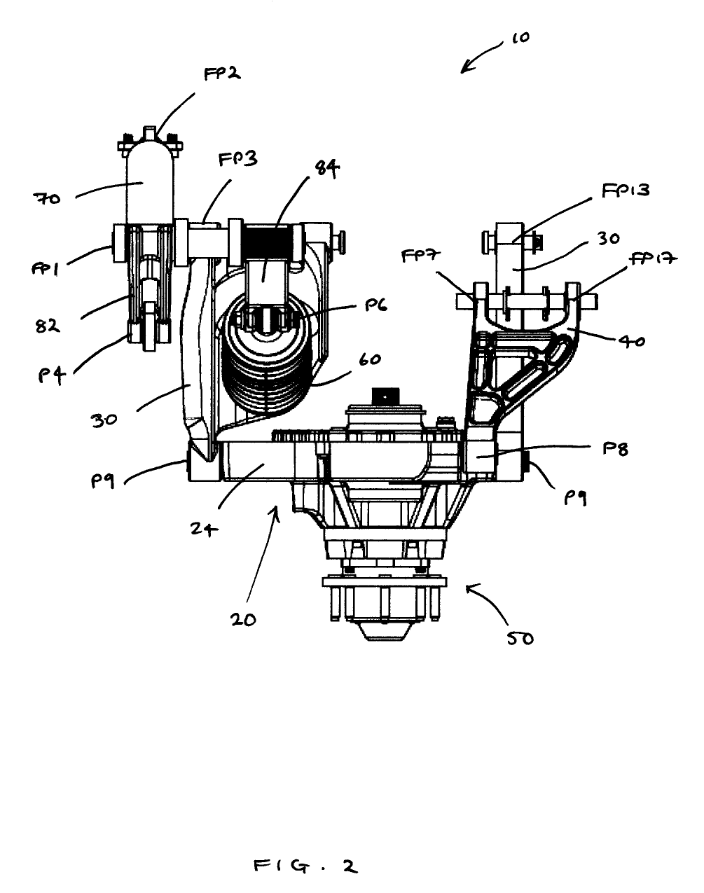

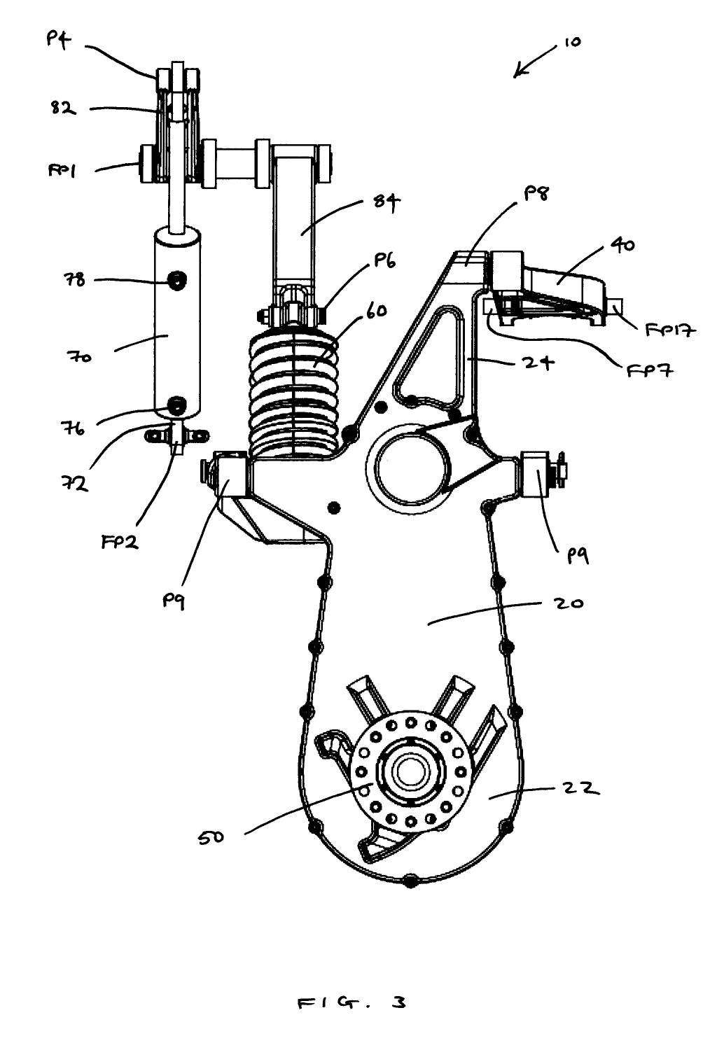

Referring first to FIGS. 1 to 3, there is shown a retractable wheel assembly 10 (wheel omitted for clarity) in a protracted position for use in an amphibian in land mode. The retractable wheel assembly 10 can be used for steerable wheels or non-steerable wheels, for driven wheels or non-driven wheels, but for the sake of simplicity is shown here in the context of a driven but non-steered wheel. Suspension is provided by way of a spring damper suspension strut 60, but may take any suitable form such as a hyrdropneumatic strut, gas spring strut or air spring strut, for example. The amphibian (not shown) includes a prime mover for providing power where required to drive one or more of the wheels supported on each retractable wheel assembly 10 on land. The prime mover may also provide power to drive a marine propulsion unit for propelling the amphibian on water. The wheel (not shown) is rotatably connected to a suspension upright 20 (sometimes termed a hub carrier or, when steerable, a knuckle) via a wheel hub 50. The suspension upright 20 has a first upper end 24 pivotably connected to the outboard end of an upper control arm 40 via a pivot P8, and a second lower end 22 distal from the first upper end 24 and provided with the wheel hub 50 for receiving a wheel. Between the first upper end 24 and the second lower end 22, the suspension upright 20 is pivotably connected to the outboard end of lower control arms 30 via pivots P9. The upper and lower control arms 40, 30 can take any suitable form, and for example may preferably take the form of wishbone shaped arms (bifurcated) with the apex of each arm connected to the suspension upright 20 via the respective pivots P8, P9. The inboard ends of the bifurcated upper control arm 40 are pivotably connected to the amphibian (not shown) via pivots FP7, FP17, and the inboard ends of the lower control arms 30 are pivotably connected to the amphibian (not shown) via a pivots FP3, FP13. The upper control arm 40 is shorter than the lower control arms 30. Pivots FP7, FP17 and FP3, FP13 are fixedly located in position on the amphibian, save for rotation about their pivot axis (i.e. are free to pivot, but not free to undergo any translational movement). A hydraulic actuator 70 is provided to effect controlled retraction and protraction of the retractable wheel assembly 10. The non actuating end 72 of the hydraulic actuator 70 is pivotably connected to the amphibian (not shown) via a fixed pivot FP2, while the actuating rod end 74 of the hydraulic actuator 60 is pivotably connected to a first leg 82 of an angled (cranked) retract arm 80 via a pivot P4. Fixed pivot FP2 is fixedly located in position on the amphibian, save for rotation about its pivot axis. Angled (cranked) retract arm 80 comprises a central fixed pivot FP1 fixedly located in position on the amphibian, save for rotation about its pivot axis, and a second leg 84 pivotally connected to the upper end of the spring damper suspension strut 60 via a pivot P6. The spring damper suspension strut 60 comprises a lower end connected to the lower control arm 30 via a pivot P10 located nearer to the outboard pivot P9 than to the inboard pivots FP3, FP13 of the lower control arm 30. The upper and lower control arms 40, 30, the suspension upright 20 and the spring damper suspension strut 60 may, if preferred, together form a double wishbone suspension unit. Of course, double wishbone suspension units are well known in road only going vehicles and provide good levels of road holding ability. The ride handling characteristics of this layout are well known, and so can be adapted or tuned to the specific requirements of the amphibian, in order to provide a comfortable ride and/or good cornering capabilities, and/or good off road capability.

The retractable wheel assembly 10 has a retraction linkage arrangement which can rigidly support the suspension unit in a protracted position to allow the suspension unit to function when the amphibian is operated on land. The retractable wheel assembly 10 is further operable to retract the suspension unit along with the wheel assembly when the amphibian is operated on water.

All of the pivots FP1, FP3, P4, P6, FP7, P8, P9, FP13 and FP17 allow for relative rotational movement of the attached members, generally in substantially the same plane or parallel planes. Further, the pivots FP1, FP3, P4, P6, FP7, P8, P9, FP13 and FP17 rotate about axes each generally or substantially parallel to a longitudinal axis of the amphibian. This arrangement provides for wheel retraction about a longitudinal axis of the amphibian.

A wheel, when attached to the wheel hub 50, is therefore secured to the amphibian via multiple points FP1, FP3, FP13, FP7, FP13, FP17, at least some of which are spaced with respect to another along the longitudinal axis of the amphibian. The resulting wheel retraction assembly is therefore configured to withstand the forces experienced by the wheel even in off-road conditions when operated on land.

Operation of the wheel retraction assembly 10 will now be described.

When the amphibian is operated in a land mode (including entry into and egress from the water), the wheel retraction assembly 10 is in a fully protracted position as shown in FIGS. 1 to 3, in which the wheel 100 (not shown) is in contact with a road or other ground surface. The hydraulic actuator 70 is extended and locked in position, hydraulically or mechanically or both, so that the wheel retraction assembly remains in an ‘overcentre’ position. In the protracted position shown in FIG. 1, there is illustrated a protracted centre line CP defined by a line which intersects the central fixed pivot FP1 of the angled (cranked) retract arm 80 and the pivot point P10 of the lower end of the spring damper suspension strut 60. Pivot P6 at the upper end of the spring damper suspension strut 60 can be seen to have passed through the protracted centre line CP and on to lie on an overcentre line OC spaced laterally on the overcentre side of the protracted centre line CP. A bar or other such member (not shown) may be provided to act as a mechanical end stop to limit the travel of the overcentre action. In this position, loads experienced by and transferred from the wheel mounted on the wheel hub 50 are transmitted via the suspension upright 20 through pivot P9 and on through the lower control arm 30 via pivot P10 to the lower end of the spring damper suspension strut 60. The spring damper suspension strut 60 is constrained at its upper end by pivot P6 located in the overcentre position of line OC, thereby resisting axial movement by virtue of the mechanical lock provided by angled (cranked) retract arm 80 which is held in place by fixed pivot FP1. Rotation of angled (cranked) retract arm 80 about fixed pivot FP1 and pivot P4 is resisted by virtue of a hydraulically locked hydraulic actuator 70. Hydraulic lock of the hydraulic actuator 70 is achieved by shutting of inlet/outlet valves 76, 78 to prevent hydraulic fluid flow in a known manner, but any suitable form of lock may be employed (e.g. mechanical, electromechanical, pin, magnetic, etc.). The overcenter position of the retraction link (FP1-P6) does not require, on a relative basis, a large force to be maintained if such a force is applied in a direction approximately perpendicular to the axis of the link near the pivot P6. Therefore, a spring-loaded gate feature, detent, pin, magnetic or electro-magnetic lock or other similar device can be employed in place of, or in addition to, a hydraulic or other positive locking mechanism. The actuator can easily overcome this force when the retractable wheel and/or track drive assembly is either protracted into, or retracted from, its land engaging position. However, in the event the actuator cannot function to maintain this force (e.g. if hydraulic pressure were lost), the detent mechanism (or other equivalent feature(s) employed) will maintain sufficient force to allow continued operation on land. The non actuating end 72 of the hydraulic actuator 70 is fixed in position (but pivotable) by virtue of its connection to the amphibian (not shown) via pivot FP2, while the actuating rod end 74 of the hydraulic actuator 60 is pivotably connected (and can move in terms of axial extension and retraction) to the first leg 82 of angled (cranked) retract arm 80 via pivot P4. As such, all bump and rebound is transmitted to and attenuated by the spring damper suspension strut 60. The received forces act along the longitudinal axis of the spring damper suspension strut 60, which at its upper end is biased towards and on the overcentre side, acting to urge the retractable wheel assembly further overcentre and not in a direction which seeks to force a retraction of the wheel retraction assembly. A bar or other such member (not shown) may be provided to act as a mechanical end stop to limit the travel of the overcentre action. As the amphibian is driven, the suspension unit acts in a known manner. In bump travel, the wheel retraction assembly remains locked in place in an overcentre condition, providing fixed inboard pivot points FP3, FP13, FP7, FP17 for the double wishbone suspension unit. The wheel will be urged upwardly by the bump in the road or ground surface. Upper control arm 40 and lower control arms 30 will rotate upwardly about fixed inboard pivot points FP3, FP13, FP7, FP17. Upper control arm 40 is shorter than lower control arms 30, so that the upward movement of the wheel results in a small camber change of the wheel towards an inboard side of the amphibian, and this aids road/ground holding. The spring damper suspension strut 60 is partially compressed during part bump travel, and resists the upward movement of the wheel to keep the wheel 10 in contact with the road/ground.

It will be appreciated, therefore, that during bump travel the retractable action of the wheel retraction assembly is locked stationary, and the function of the suspension unit is not affected by the ability of the wheel retraction assembly to retract the wheel in marine mode.

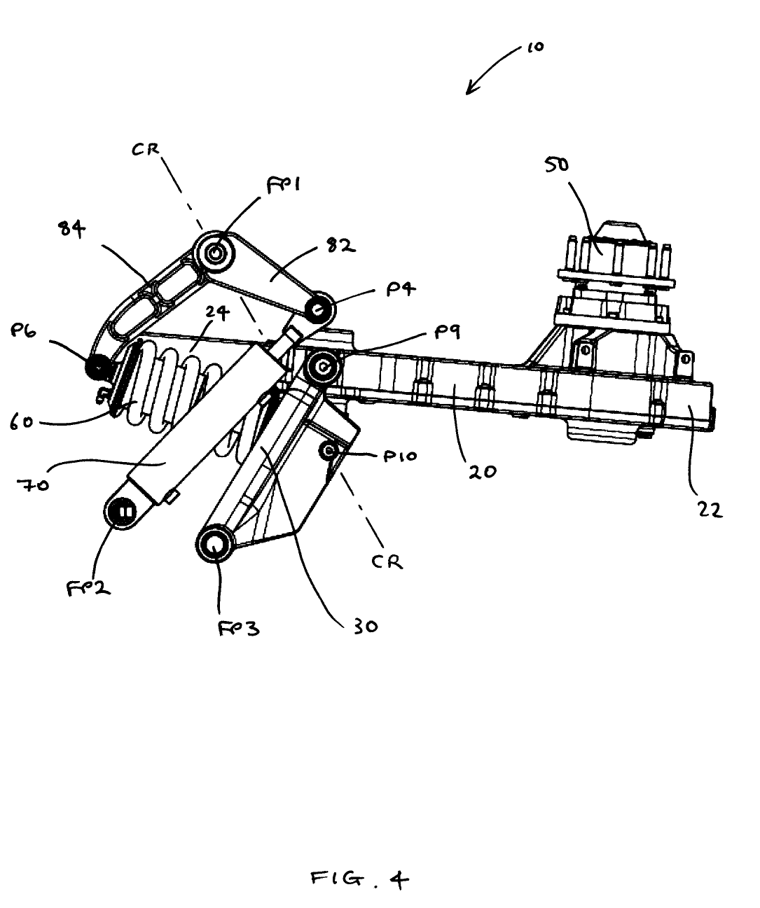

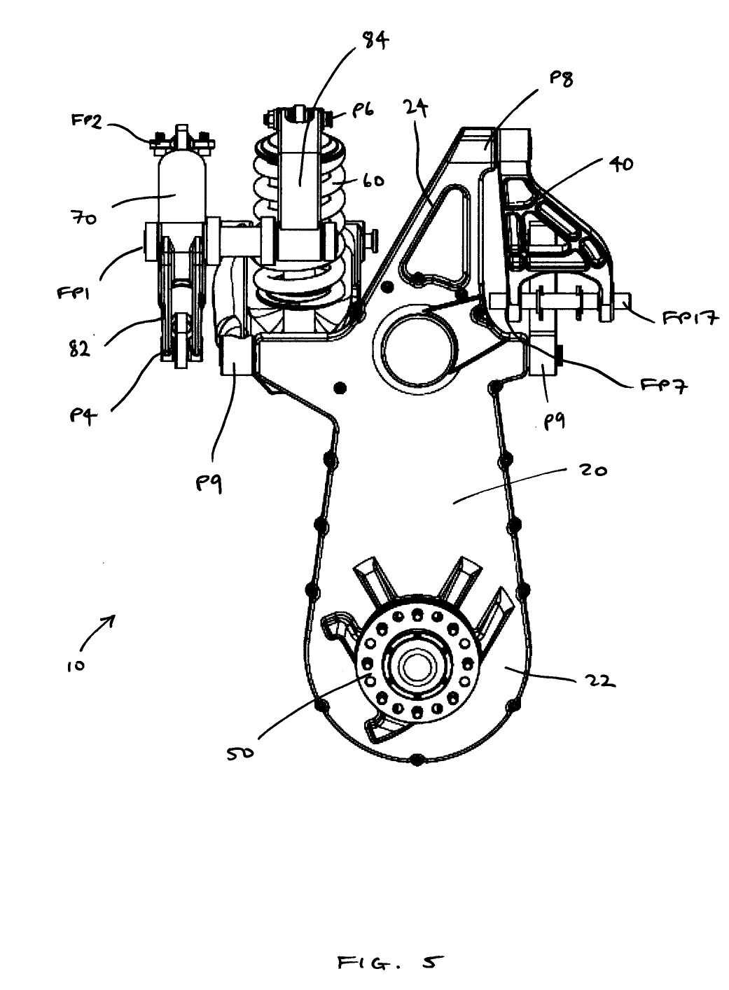

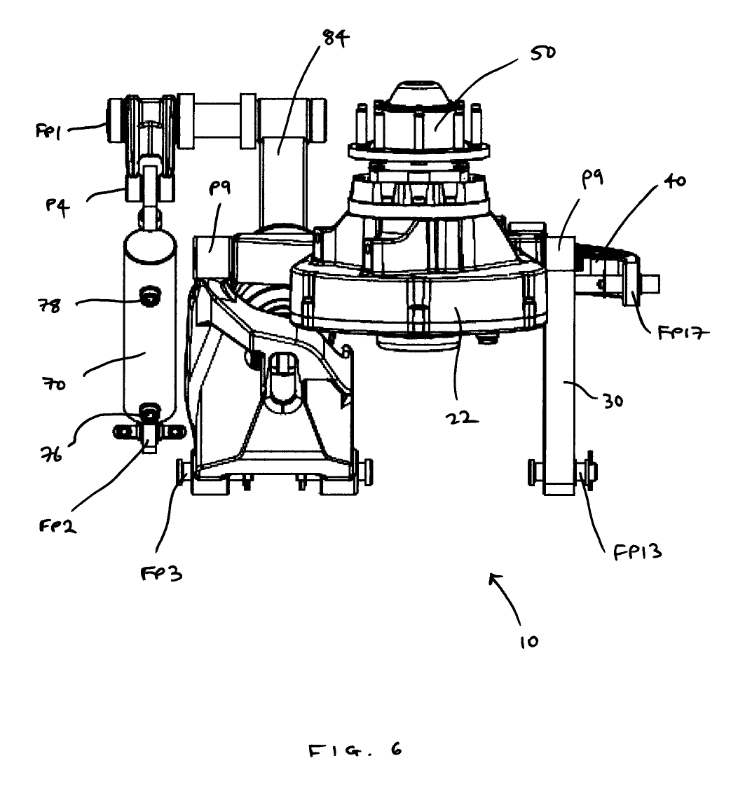

Referring next to FIG. 1 and FIGS. 4 to 6, the retraction of the wheel (not shown), will be described. The retraction is actuated by contraction of the hydraulic actuator 70 along the arrow indicated in FIG. 1 by supplying pressurised hydraulic fluid to inlet/outlet port 78 and allowing hydraulic fluid to escape from inlet/outlet port 76. Since the hydraulic actuator 70 is securely attached to the amphibian by the fixed pivot FP2, the retraction urges pivot P4 generally towards fixed pivot FP2. The pivot P4 provided on the end of the first leg 82 of angled (cranked) retract arm 80 is therefore rotated downwardly and inboard as indicated by the arrow in FIG. 1. Angled (cranked) retract arm 80 itself thus rotates counter-clockwise around its central fixed pivot FP1 fixedly located in position on the amphibian, as does second leg 84 which is in turn pivotally connected to the upper end of the spring damper suspension strut 60 via the pivot P6. The upper end of the spring damper suspension strut 60 is pulled laterally inboard around an arc as indicated by the arrow in FIG. 1, passing through the overcentre position, before continuing inboard and upwards, pulling via the lower end of the spring damper suspension strut 60 connected to the lower control arm 30 via the pivot P10. Lower control arm 30 is rotated clockwise (in real terms, but anticlockwise as shown in FIG. 1 due to it being an elevation view from the front of the amphibian) around fixed pivot points FP3, FP13, and in turn, via the pivot P9, lifts suspension upright 20 whose motion is dictated also by the upper pivot P8 at the outboard end of upper control arm 40. Upper control arm 40 rotates clockwise (in real terms, but anticlockwise as shown in FIG. 1 due to it being an elevation view from the front of the amphibian) around fixed pivot FP7, FP17 in an arc as indicated by the arrow in FIG. 1. The clockwise rotation (in real terms, but anticlockwise as shown in FIG. 1 due to it being an elevation view from the front of the amphibian) of the upper control arm 40 and lower control arm 30 carries the suspension upright 20 and wheel upwardly and inboard. Initially, the movement of the wheel is substantially as if it is rotated around pivot P9. Note, prior to retraction (in droop mode in the water), the spring damper suspension strut 60 tends to expand as the weight of the amphibian is taken off the wheel. The expansion of the spring damper suspension strut 60 is limited by a rebound stop (not shown) and reaches a maximum. The longer length of the lower control arm 30 relative to the upper control arm 40, coupled with the relatively long length of the suspension upright 20, provides for long vertical and inboard travel of the retractable wheel assembly on retraction, allowing the wheel to be retracted above the waterline of the amphibian, even when a deep V-hull is employed and is cornering. The amphibian is able to plane on water without drag caused by the wheel. FIGS. 4 to 6 correspond and show the retractable wheel assembly in the fully retracted position for use of the amphibian on water.

For protraction of the wheel, the protraction process is actuated by extension of the hydraulic actuator 70 by supplying pressurised hydraulic fluid to inlet/outlet port 76 and allowing hydraulic fluid to escape from inlet/outlet port 78. The retraction process described above is essentially operated in reverse, and finishes with the upper end of the spring damper suspension strut 60 being pushed laterally outboard around an arc, opposite to that indicated by the arrow in FIG. 1, and passing through the protracted centre line CP and on through to the overcentre position OC where the wheel retraction assembly is locked as described above.

The retractable wheel assembly provides substantial lifting capability. It may, therefore, in certain circumstances (e.g. if the amphibian is beached or runs aground) be possible for the wheels to be protracted to lift the amphibian upwards. Since the rotational axis of the wheels is close to parallel to the ground during the final stages of deployment, the amount of tyre scrub in such a deployment is kept low.

Each feature disclosed in this specification (including the accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features. In addition, all of the features disclosed in this specification (including the accompanying claims, abstract and drawings), and/or all of the steps of any method or process so disclosed, may be combined in any combination, except combinations where at least some of such features and/or steps are mutually exclusive. Accordingly, while different embodiments of the present invention have been described above, any one or more or all of the features described, illustrated and/or claimed in the appended claims may be used in isolation or in various combinations in any embodiment. As such, any one or more feature may be removed, substituted and/or added to any of the feature combinations described, illustrated and/or claimed. For the avoidance of doubt, any one or more of the features of any embodiment may be combined and/or used separately in a different embodiment with any other feature or features from any of the embodiments.

For example, hydraulic actuator 70 may take any suitable form of actuator, electric, pneumatic and/or hydraulic and/or any hybrid thereof. Similarly, the spring damper suspension strut 60 may take any suitable form, such as torsion bar and damper system, hydropneumatic units and/or gas or air springs and/or any hybrid thereof. Whilst wheels have been described throughout as the land propulsion means, track drives or individual track drives (i.e. to replace a single wheel) may be used as an alternative or in combination with wheels.

Whereas the present invention has been described in relation to what is presently considered to be the most practical and preferred embodiments, it is to be understood that the invention is not limited to the disclosed arrangements but rather is intended to cover various modifications and equivalent constructions included within the scope of the appended claims.

1. A retractable land propulsion for an amphibian comprising:
a retraction linkage movable between a protracted position and a retracted position;
an actuator for moving the retraction linkage between the protracted position and retracted position; and
at least one of a wheel and a track drive, wherein:
when the retraction linkage is protracted then the retraction linkage supports the at least one of the wheel and the track drive in a ground engaging position for use on land;
the retraction linkage comprises a component Wherein at least a portion of the component passes through an overcentre position on protraction to prevent forces received in use via the at least one of the wheel and the track drive from acting to retract the retraction linkage.

2. The retractable land propulsion assembly as claimed in claim 1, wherein:
when the retraction linkage is retracted then the retraction linkage supports the at least one of the wheel and the track drive in a non ground engaging position for use on water.

3. The retractable land propulsion assembly as claimed in claim 1 further comprising suspension assembly.

4. The retractable land propulsion assembly as claimed in claim 3 wherein the suspension assembly is also retractable and protractable upon actuation of the actuator.

5. The retractable land propulsion assembly as claimed in claim 3, wherein the suspension assembly comprises at least one of a spring damper strut, a torsion bar and a damper, a hydropneumatic unit, a gas spring, and an air spring.

6. The retractable land propulsion assembly as claimed in claim 1, wherein the actuator comprises at least one of a hydraulic actuator, an electric actuator, and a pneumatic actuator.

7. The retractable land propulsion assembly as claimed in claim 7, wherein the retraction linkage comprises an upper control arm, a lower control arm and a suspension upright.

8. The retractable land propulsion assembly as claimed in claim 7 wherein the retraction linkage further comprises a retract arm.

9. The retractable land propulsion assembly as claimed in claim 7, wherein the upper control arm and lower control arm comprise wishbones.

10. The retractable land propulsion assembly as claimed in claim 1 further comprising at least one of a locking arrangement, a holding arrangement, and an urging arrangement to lock, hold and urge, respectively, the retraction linkage in the overcentre position after protraction.

11. The retractable land propulsion assembly as claimed in claim 1, wherein the at least one of the wheel and track drive is retractable and protractable about at least one axis generally or substantially perpendicular to an axis of rotation of the at least one of the wheel and the track drive.

12. The amphibian comprising at least one of the land propulsion assembly of claim 1.

13. The amphibian as claimed in claim 12, wherein the at least one of the wheel and the track drive may be retracted above a water line for use on water, and wherein at least a portion of the at least one of the wheel and the track drive is protracted below a lowermost part of a hull of the amphibian for use on land.

14. The amphibian as claimed in claim 12, wherein the at least one of the wheel and the track drive may be retracted above a lowermost part of the hull of the amphibian for use on water, and wherein at least a portion of the at least one of the wheel and the track drive is protracted below the lowermost part of the hull for use on land.

15. The amphibian as claimed in claim 12, wherein the at least one of the wheel and the track drive is retractable and protractable about at least one axis substantially parallel to a longitudinal axis of the amphibian.

16. The amphibian as claimed in claim 12, wherein the amphibian further comprises a prime mover and a marine propulsion unit and when operated in a marine mode the marine propulsion unit can power the amphibian to a speed where sufficient hydrodynamic lift is achieved for the amphibian to plane.

17. The amphibian as claimed in claim 12, wherein when the amphibian is operated in a land mode it can be driven in any available driven wheel configuration, including at least one of one, two, three, four, five and six wheel drive rack drive.

18-19. (canceled)
